(19) United States
(12) Patent Application Publication
(10) Pub. No.: US 2010/0040857 A1
(43) Pub. Date: Feb. 18, 2010

(54) APPARATUS AND METHOD FOR MAKING REACTIVE POLYMER PRE-PREGS

(75) Inventor: Marcel Jakob Schubiger, Galgenen (CH)

Correspondence Address: GFD PATENTS, LLC, P.O. BOX 752, CLIFTON PARK, NY, 12065, US

(73) Assignee: IQ TEC SWITZERLAND GMBH, Galgenen (CH)

(21) Appl. No.: 12/605,336

(22) Filed: Oct. 24, 2009

Related U.S. Application Data
(63) Continuation of application No. 12/414,241, filed on Mar. 30, 2009.
(60) Provisional application No. 61/040,710, filed on Mar. 30, 2008.
(60) Provisional application No. 61/108,481, filed on Oct. 24, 2008.

(51) Int. Cl. B32B 27/04; B05B 7/16; B05D 3/00

(52) U.S. Cl. 428/297.4; 118/302; 427/189

(57) ABSTRACT

A method and apparatus for making a reactive polymer pre-impregnated reinforcement material, comprising applying a substantially non-volatile composition of substantially solid particles of a reactive thermoset resin to a porous substrate at ambient temperature, initially by melting a first portion of the particles of the reactive thermoset resin. The first portion of the particles of the reactive thermoset resin flows into interstices of at least one layer of the porous substrate and a remaining portion of the particles of the substantially non-volatile composition remains solid. An apparatus for forming a drapable polymer pre-impregnated reinforcement material, comprising: a feeder roll of reinforcement material, a receiver roll of drapable polymer pre-impregnated reinforcement material and a conveyor belt having the reinforcement material from the feeder roll thereon, and a particle deposition hopper adapted to deposit between 20 g/(meter squared) and about 2,000 g/(meter squared) of the substantially non-volatile composition.

### FIELD OF THE INVENTION

The present invention relates generally to an apparatus and method for making reactive polymer pre-impregnated reinforcement materials (pre-pregs). More specifically, the present invention relates to an apparatus and method for impregnating reinforcing materials, such as fabrics or assemblages of reinforcing fibers, with heat curable thermoset resins.

### BACKGROUND

There is a growing demand by industry, governmental regulatory agencies and consumers for durable and inexpensive products that are functional comparable or superior to metal products. This is particularly true in the automotive industry. Developers and manufacturers of these products are concerned with the strength parameters, such as impact, bending, stretching, and twisting resilience. To meet these demands, a number of reactive thermoplastic composite pre-pregs and thermoplastic based fully polymerized sheets have been engineered.

Therefore there is a need for an improved apparatus and method for making reactive polymer pre-impregnated reinforcement materials (pre-pregs).

### SUMMARY OF THE INVENTION

A first aspect of the present invention provides a method for making a reactive polymer pre-impregnated reinforcement material, comprising: providing a substantially non-volatile composition, comprising substantially completely solid particles of at least one heat curable thermoset resin, wherein the only volatile components of the substantially non-volatile composition are residual water or residual solvent; depositing a layer of the substantially non-volatile composition on a fabric or assemblage of reinforcing fiber to be impregnated, wherein the particles of the substantially non-volatile composition are solid at ambient temperature and are applied to the fabric or assemblage of reinforcing fiber to be impregnated at ambient temperature; forming a pre-preg by heating the substantially completely solid particles of the substantially non-volatile composition, so that the substantially completely solid particles partially melt, wherein the fabric or assemblage is impregnated by the partially melted composition, and the partially melted solid particles of the composition adhere to the fabric or assemblage of reinforcing fiber.

A second aspect of the present invention provides a drapable polymer pre-impregnated reinforcement material, comprising: a porous substrate having at least one layer; randomly spaced particles of a substantially non-volatile composition, comprising at least one reactive thermoset resin(s), thereon, wherein the only volatile components of the substantially non-volatile composition are residual water or residual solvent; wherein a portion of each of the randomly spaced particles is impregnated into interstices of the first surface of the porous substrate, therein, and wherein a space, therebetween, separates adjacent randomly spaced particles.

A third aspect of the present invention provides a method for forming a drapable polymer pre-impregnated reinforcement material, comprising: providing a the porous substrate having having at least one layer; and forming an array of a substantially non-volatile composition, comprising substantially uniformly spaced and substantially completely solid reactive thermoset particles, and covering a portion of the at least one layer, thereon, wherein the only volatile components of the composition are residual water or solvent: partially melting the array of substantially completely solid reactive thermoset particles; and fixing the partially melted array by impregnating the melt into interstices of a portion of the at least one layer of the porous substrate, therein, wherein a remaining portion of the at least one layer remains uncovered by the array.

A fourth aspect of the present invention provides an apparatus for forming a drapable polymer pre-impregnated reinforcement material, comprising: a feeder roll of reinforcement material; a receiver roll of drapable polymer pre-impregnated reinforcement material; and a conveyor belt having the reinforcement material from the feeder roll thereon; a particle deposition hopper charged with a substantially non-volatile composition, comprising substantially completely solid reactive thermoset particles, wherein the only volatile components of the substantially non-volatile composition are residual water or solvent: a heating unit adapted to substantially uniformly maintain a temperature of the substantially non-volatile composition on at least one layer of the reinforcement material for a residence time, during which the particles of the composition on the at least one layer of the reinforcement material reside in the oven; a conveyor belt, wherein residence time that the particles of the composition reside on the at least one layer of the reinforcement material is based on the conveyor belt's rate.

A fifth aspect of the present invention provides a method for forming a thermoset composite sheet, comprising: providing at least one feeder roll, wherein one of the feeder rolls provides reinforcement material, a receiver roll of drapable polymer pre-impregnated reinforcement material and a conveyor belt having the reinforcement material from the feeder roll thereon, wherein the reinforcement material has a fiber content based on total weight of the thermoset composite sheet; providing a particle deposition hopper charged with reactive thermoset particles of a substantially non-volatile composition, wherein the only volatile components of the substantially non-volatile composition are residual water or solvent, and adapted to deposit between 20 g/m² and about 2,000 g/m² of the reactive thermoset particles of the substantially non-volatile composition, based on the surface area (m²) of the reinforcement material; providing a heating unit adapted to substantially uniformly maintain the reactive thermoset particles of the substantially non-volatile composition on a first surface of the reinforcement material between about 40° C. and about 230° C. during a residence time that the reactive thermoset particles of the substantially non-volatile composition on at least one layer of the reinforcement material reside in the oven; providing a conveyor belt wherein residence time that the reactive thermoset particles of the substantially non-volatile composition on the at least one layer of the reinforcement material is based on the conveyor belt's rate; and providing a belt press after the heating unit, wherein the belt press has a hot zone and a cold zone, wherein the hot zone is adapted to receive drapable polymer pre-impregnated reinforcement material and to heat said pre-impregnated reinforcement material to less than or equal to about 260° C. and greater than or equal to about 0.01 bar pressure, and wherein the cold zone is adapted to receive a fully impregnated and cured thermoset composite sheet and to cool said fully impregnated and cured thermoset composite sheet to about 25° C.

A sixth aspect of the present invention provides a method for making a reactive polymer pre-impregnated reinforcement material, comprising: providing a layer of substantially completely solid particles of a heat curable thermoset resin on a liner, wherein the particles of heat curable thermoset resin are solid at ambient temperature and are applied to the liner at ambient temperature; heating the curable thermoset resin, so that the solid particles partially melt; and applying a layer of fabric or assemblage of reinforcing fiber to be impregnated to the partially melted layer of particles of the heat curable thermoset resin on the liner, wherein the fabric or assemblage of reinforcing fiber is impregnated by the partially melted particles of thermoset resin, and the solid particles adhere to the fabric or assemblage of reinforcing fiber.

A seventh aspect of the present invention provides A method for making a reactive polymer pre-impregnated reinforcement material, comprising: providing a substantially non-volatile mixture, comprising substantially completely solid particles of a heat curable thermoset resin and substantially completely solid particles of a heat curable thermoplastic resin, wherein the only volatile components of the substantially non-volatile mixture are residual water or solvent: depositing a layer of the mixture on a fabric or assemblage of reinforcing fiber to be impregnated, wherein the particles of the substantially non-volatile mixture are solid at ambient temperature and are deposited onto the fabric or assemblage of reinforcing fiber to be impregnated at ambient temperature; and forming a pre-preg by heating the particles of the substantially non-volatile mixture, so that the solid particles partially melt, wherein the fabric or assemblage is impregnated by the partially melted thermoset resin, and the partially melted solid particles adhere to the fabric or assemblage of reinforcing fiber

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts a longitudinal cross-sectional view of an apparatus for making a heat curable polymer pre-impregnated reinforcement material, according to embodiments of the present invention;

FIG. 2 depicts a longitudinal cross-sectional view of the apparatus taken along an axis 2-2 of FIG. 1, according to embodiments of the present invention;

FIG. 3A depicts a longitudinal cross-sectional view of the apparatus taken along an axis 3A-3A of FIG. 1, according to embodiments of the present invention;

FIG. 3B depicts a longitudinal cross-sectional view of the apparatus taken along an axis 3B-3B of FIG. 1, according to embodiments of the present invention;

FIG. 4 depicts a longitudinal cross-sectional view of an apparatus for pre-heating a first surface of a substrate of a prepreg, prior to thermally fixing particles of a reactive thermoplastic or thermoset resin on the first surface of the prepreg, according to embodiments of the present invention;

FIG. 5 depicts a longitudinal cross-sectional view of the apparatus taken along an axis 5-5 of FIG. 4, according to embodiments of the present invention;

FIG. 6A depicts a longitudinal cross-sectional view of the particle prepreg retrieval stage 237 of the apparatus 253 taken along an axis 6A-6A of FIG. 4;

FIG. 6B depicts a longitudinal cross-sectional view of the particle prepreg retrieval stage 237 of the apparatus 253 taken along an axis 6B-6B of FIG. 4; and

FIG. 7 is a flow diagram of a method for making a drapable or non-drapapable pre-preg, according to embodiments of the present invention;

FIGS. 8-9 is a flow diagram of a method for making a drapable or non-drapapable pre-preg, according to embodiments of the present invention;

FIG. 10 depicts a longitudinal cross-sectional view of an apparatus for making a heat curable polymer pre-impregnated reinforcement material, according to embodiments of the present invention;

FIG. 11 depicts a longitudinal cross-sectional view of an apparatus for making a free-form heat curable polymer pre-impregnated reinforcement material, according to embodiments of the present invention; and

FIGS. 12-13 depicts a longitudinal cross-sectional view of an apparatus for making a heat curable polymer pre-impregnated reinforcement material, according to embodiments of the present invention.

### DESCRIPTION OF THE INVENTION

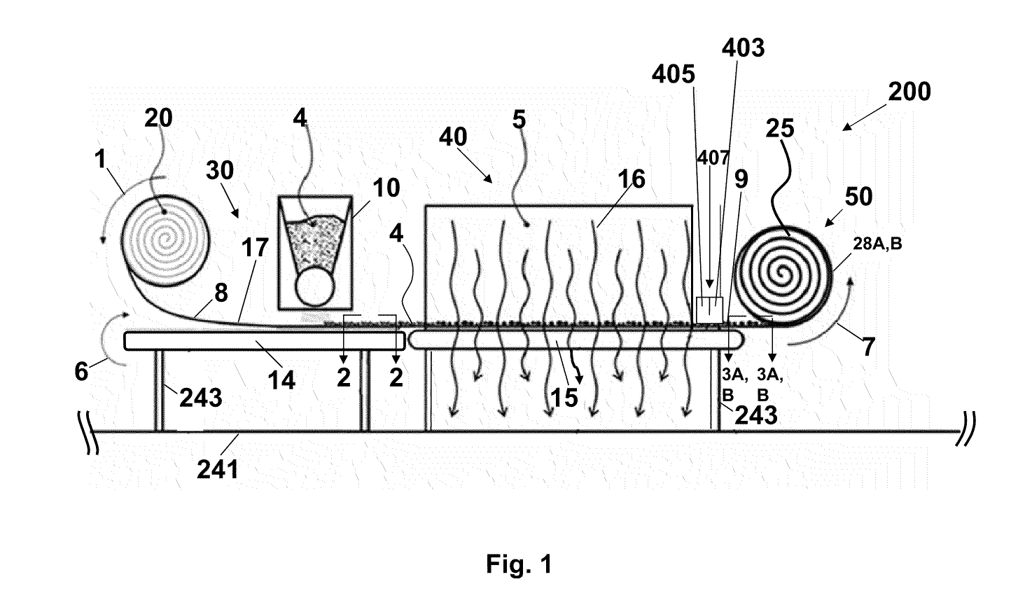

FIG. 1 is a schematic diagram illustrating a longitudinal cross-sectional view of an apparatus 200 for manufacturing a polymer pre-impregnated reinforcement material (prepreg) 28. The apparatus 200 comprises: a particle deposition stage 30, a thermal fixing stage 40, an optional belt press 407, and a prepreg retrieval stage 50.

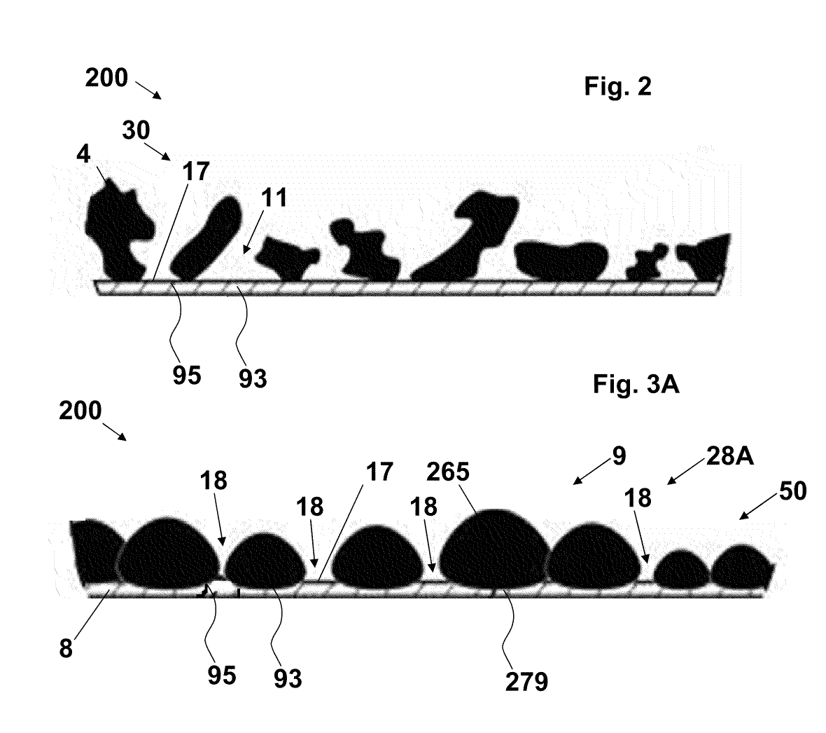

The particle deposition stage 30 comprises: a first steel-net conveyor belt 14; at least one supply roll(s) 20 for supplying a porous substrate 8; at least one hopper(s) 10 being charged with particles 4 of reactive (polymerizable) thermoplastic or thermoset resin; an array of particles 4 of reactive thermoplastic or thermoset resin deposited onto a first surface 17 of the porous substrate 8. The at least one supply roll(s) 20 may unroll by rotating in a direction of the arrow 1 about an axis orthogonal to a plane of the first surface 17 of the porous substrate 8. FIGS. 1-2 depict the particles 4 of reactive (polymerizable) thermoplastic or thermoset resin may advantageously be deposited onto the first surface 17 of the porous substrate 8, wherein both the particles 4 and the porous surface of the porous substrate 8 are advantageously at ambient temperature.

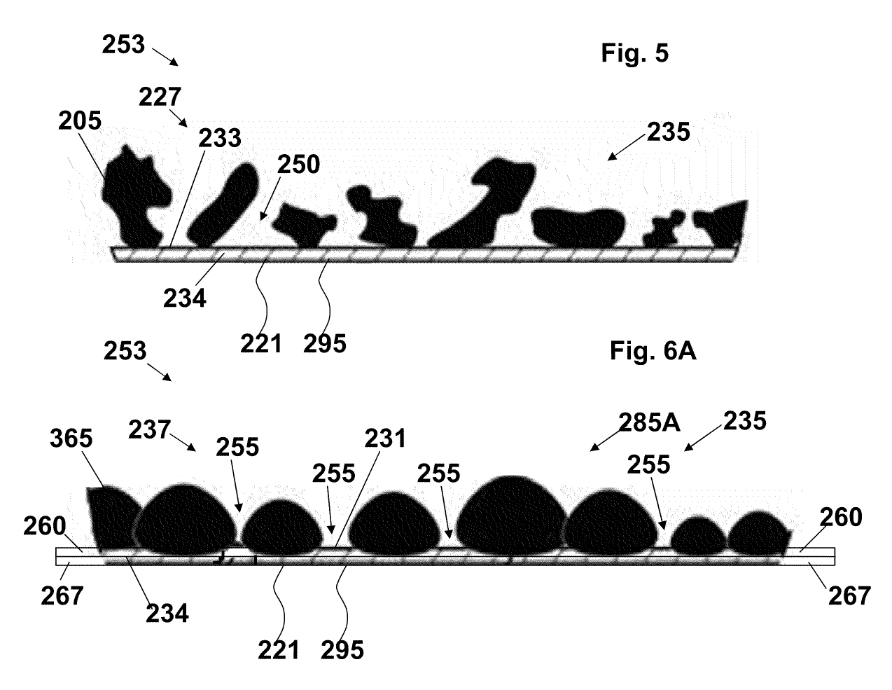

FIGS. 4-6 depict an alternative embodiment, in which the particles 205 of reactive (polymerizable) thermoplastic or thermoset resin may advantageously be deposited onto the first surface 234 of the porous substrate 233, wherein only the particles 205 are advantageously at ambient temperature, but the first surface 234 of the porous substrate 203 has been “pre-warmed”, to enable the particles 205 of the reactive thermoplastic or thermoset resin to adhere “immediately” to the first surface 234 of the porous substrate 233. In the embodiment depicted in FIGS. 4-6, and described in associated text, infra, the inventors report prevention of “rolling away”, or “blowing away” of the particles 205 when they are deposited onto the first surface 234 of the porous substrate 233 by pre-warming the first surface 234 of the porous substrate 233.

A range of particle size distribution of the particles 8, 205 of reactive (polymerizable) thermoplastic or thermoset resin may advantageously be greater than the range of particle size distribution of powders used in certain powder impregnation methods for infusing reactive thermoplastic powders into the interstices 93 between fibers 95, or fiber bundles, of the porous substrate 8, 205. In one embodiment the particles 8 of the reactive (polymerizable) thermoplastic or thermoset resin may advantageously be greater than between 150 to 1000 μm. In one embodiment the particles 8 of the reactive (polymerizable) thermoplastic or thermoset resin may advantageously have a diameter ranging from between 2 to 5 mm.

The thermal fixing stage 40 comprises: a second steel-net conveyor belt 15 for picking up the porous substrate 8 having the particles 4 of reactive (polymerizable) thermoplastic or thermoset resin, thereon, from the first steel-net conveyor belt 14 to convey the particles 4 into oven 5. The oven 5 may provide hot air laminar flow 16, warming the porous substrate 8 having the particles 4 of the reactive (polymerizable) thermoplastic or thermoset resin thereon and the second steel net conveyor 15. The oven 5 may be any appropriate heating device capable of raising the temperature of the substrate 8 between about 190° C. and 220° C. in a residence time between 1 and 5 minutes. In one embodiment, the porous substrate 8 may be a fiber reinforcement fabric, a glass mat, or a fiber bed.

The apparatus 200 may optionally be equipped with a belt press 407 after the heating unit 5, 209, wherein the belt press 407 has a hot zone 405 and a cold zone 403, wherein the hot zone 405 is adapted to receive drapable polymer pre-impregnated reinforcement material 28B, 285B and to heat said pre-impregnated reinforcement material 28B, 285B to less than or equal to 250° C. and greater than or equal to 0.01 bar pressure, and wherein the cold zone 403 is adapted to receive a fully impregnated and cured thermoplastic composite sheet and to cool said fully impregnated and cured thermoplastic composite sheet to 25° C.

The first and second steel-net conveyor belts 14, 15 may be supported by legs 243 that rest on manufacturing floor 241. The first and second steel-net conveyor belts 14, 15 may rotate in a direction of the arrow 6 to carry the porous substrate 8 having the particles 4 of reactive (polymerizable) thermoplastic or thermoset resin, thereon, from the first steel-net conveyor belt 14 to convey the particles 4 into oven 5.

The prepreg retrieval stage 50 comprises: at least one retrieving roll(s) 25 for retrieving the prepreg 28; a prepreg 28, wherein the prepreg 28 comprises the porous substrate 8 from supply roll 20, and an array 9 of thermally fixed particles, thereon. The at least one retrieving roll(s) 25 may retrieve the prepreg 28 by rotating in a direction of the arrow 7 about an axis orthogonal to a plane of the first surface 17 of the porous substrate 8.

FIG. 2 depicts a longitudinal cross-sectional view of the particle distribution stage 30 of the apparatus 200 taken along an axis 2-2 of FIG. 1. FIG. 2 depicts first surface 17 of the porous substrate 8, on which the particles 4 of reactive (polymerizable) thermoplastic or thermoset resin have been deposited, thereon. The porous substrate 8 comprises a first surface 17, having particles 4, thereon, and spaces 11, therebetween. In one embodiment, the porous substrate 8 is a fiber reinforced fabric, or a fiber bed, and the particles 4 of the reactive (polymerizable) thermoplastic or thermoset resin, thereon, are granules. A particle size distribution of the particles 8 of reactive (polymerizable) thermoplastic or thermoset resin may advantageously be greater than the range of particle size distribution of powders used in certain powder impregnation methods for infusing reactive (polymerizable) thermoplastic powders into the interstices 93 between fibers 95 or fiber bundles of the porous substrate 8. In one embodiment the particles 4 of the reactive (polymerizable) thermoplastic or thermoset resin may advantageously be greater than between 150 to 1000 μm. In one embodiment the particles 4 of the reactive (polymerizable) thermoplastic or thermoset resin may advantageously have a diameter ranging from between 2 to 5 mm. In one embodiment, a shape of the particles 4 of the thermoplastic or thermoset resin may be a granule, pellet, flake, pastille, needle, chunks, or a chip.

Hereinafter, a “granule” is defined as a particle larger than a sand grain and smaller than a pebble, between 2 mm and 4 mm in diameter. Hereinafter a “pellet” is defined as a small rounded, spherical, or cylindrical body, having a diameter between about 2 mm and 5 mm.

Hereinafter a “flake” is defined as a particle having a surface area greater than 2 mm² and a thickness between 0.02 mm and 0.1 mm.

Hereinafter, a “pastille” is an enrobed active catalytic thermoplastic orthermoset resin material with a protective coating. The pastille may be prepared using a low-shear jacketed blender and a pastillator. The resultant pastille varies in shape and has a diameter of from about 2 mm to about 100 mm and a thickness of 1 mm to 10 mm.

Hereinafter a “needle” is defined as narrow and long and pointed; as pine leaves.

Hereinafter a “chunk” is defined as a short, thick piece or lump.

Hereinafter a “chip” is defined as a small fragment of reactive (polymerizable) thermoplastic or thermoset resin broken off from the whole.

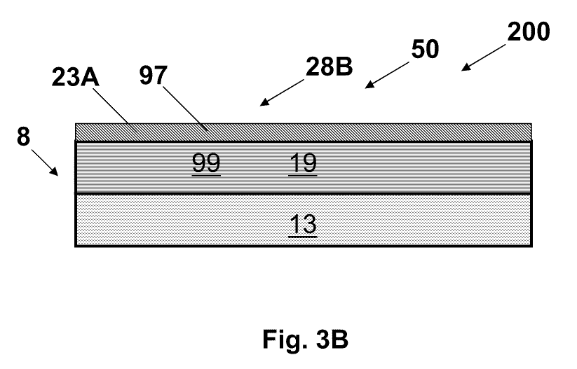

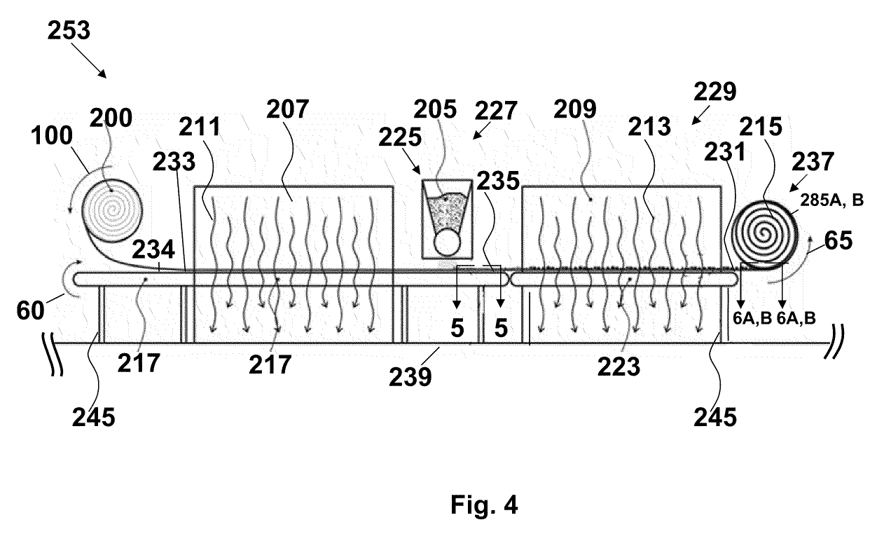

FIG. 3A depicts a longitudinal cross-sectional view of the particle prepreg retrieval stage 50 of the apparatus 200 taken along an axis 3A-3A of FIG. 1. FIG. 3A depicts a drapable prepreg 28. The prepreg 28 is drapable because an array 9 of thermally fixed particles 265 are thermally fixed by partially melting the particles 4 of reactive (polymerizable) thermoplastic or thermoset resin shown in FIG. 2. The partially melted reactive (polymerizable) thermoplastic or thermoset resin particles 265, shown in FIG. 3A, may flow into the interstices 93 between the fibers 95 or fiber bundles of the porous substrate 8, resulting in the particles 265 becoming thermally fixed to the fibers or fiber bundles of the porous substrate 8 when the reactive (polymerizable) thermoplastic or thermoset resin crystallizes or resolidifies when the prepreg 28 cools below the melting point of the reactive (polymerizable) thermoplastic or thermoset resin after coming out of oven 5 on cooling in the prepreg 28 retrieval stage 50. The prepreg 28 is drapable because an array 9 of thermally fixed particles 265 are thermally fixed to the first surface 17, thereon, and separated by spaces 18. Alternatively, a non-drapable prepreg 28 may be formed by completely melting the low melt viscosity reactive (polymerizable) thermoplastic or thermoset resin particles 4 in oven 5 to form particles 265.

FIG. 3B depicts a longitudinal cross-sectional view of the particle prepreg retrieval stage 50 of the apparatus 200 taken along an axis 3B-3B of FIG. 1. The prepreg 28A, shown in FIG. 3B, may be non-drapable because an at least one layer(s) 97, 19 of reactive (polymerizable) thermoplastic or thermoset resin has been formed that does not have voids. In one embodiment, the reactive (polymerizable) particles 4, shown in FIGS. 1-2, have been completely melted to form a layer 97 of reactive (polymerizable) thermoplastic or thermoset resin. A first portion 99 of the layer 97 may be impregnated or impressed into the interstices 93 between fibers 95 or fiber bundles of the porous substrate 8, shown in FIGS. 2, 3A. The impressed or impregnated first portion 99 of the layer 97 may form a layer 19, in which the reactive (polymerizable) thermoplastic or thermoset resin has been thermally fixed onto the fibers 93 or fiber bundles. The completely melted layer 97 may have flowed into the spaces 18 between the particles 265 of the array 9, shown in FIG. 3A, to become the layers 97 and/or 19. In another embodiment, the completely melted reactive (polymerizable) thermoplastic or thermoset resin layer 97 has melted and extends essentially completely into the substrate 8, forming the layers 19 and 13 in the substrate 8. Hereinafter, “thermally fixed” means reactive functionalities of the reactive (polymerizable) thermoplastic or thermoset resin particles 265 have become chemically bonded or attracted by Van der Wahls forces or other attractive intermolecular forces to the fibers 95 or fiber bundles of the substrate 8 during the melting process.

FIG. 3B depicts a prepreg 28B that is non-drapable because a first portion 97 of the completely melted reactive (polymerizable) thermoplastic or thermoset resin 265 has flowed into interstices 93 between fibers 95 or fiber bundles of the porous substrate 8, so that some of the melt impregnates or impresses between and among the fibers 95 or fiber bundles of the porous substrate 8, forming at least one layer 13, 19 of reactive (polymerizable) thermoplastic or thermoset resin in the porous substrate 8. A remaining portion 99 of the completely melted reactive (polymerizable) thermoplastic or thermoset resin 265 that doesn't flow into the interstices between fibers or fiber bundles of he porous substrate 8 forms the layer 23A which lies upon the first surface 17 of the porous substrate 8.

Void free laminates or composite structures may be made from drapable or non-drapable reactive (polymerizable) polymer pre-impregnated reinforcement materials (prepregs) 28. The non-drapable reactive (polymerizable) polymer pre-impregnated reinforcement materials (prepregs) 28 may be at least one layer 13, 19 or 23A of low melt viscosity reactive (polymerizable) thermoplastic or thermoset resin, having been completely melted when thermally fixed or compression molded. The combination of heat and pressure may force the low viscosity reactive (polymerizable) thermoplastic or thermoset resin to penetrate the fibers 95 or fiber bundles of the porous substrate 8 to form at least one layer 13, 19.

In one embodiment, the particles 265 of the reactive (polymerizable) thermoplastic or thermoset resin on the first surface 17 of the porous substrate 8 are reactive (polymerizable) thermoplastic or thermoset resin granules placed on top of a fiber bed and partly fused into fiber bundles of the fiber bed by impregnating particles 4 of a reactive (polymerizable) thermoplastic or thermoset resin into interstices 93 between fibers 95 in the fiber bundles of the fiber bed. Hereinafter, reactive (polymerizable) thermoplastic or thermoset resin is defined as the particles 4 of the reactive (polymerizable) thermoplastic or thermoset resin on the first surface 17 of the porous substrate 8, which can subsequently be partially polymerized or fully polymerized.

FIG. 4 depicts a longitudinal cross-sectional view of an apparatus 253 for manufacturing a polymer pre-impregnated reinforcement material (prepreg) 287. Specifically, the apparatus 253 may be for pre-heating a first surface 233 of a porous substrate 234 of a prepreg 287, prior to thermally fixing particles 205 of a reactive thermoplastic or thermoset resin on the first surface 233 of the prepreg 285.

The apparatus 253 comprises: a combined particle deposition and a thermal fixing stage 227, a prepreg finishing stage 229, and a prepreg retrieval stage 237. The at least one supply roll(s) 200 of the combined particle deposition and a thermal fixing stage 227 may unroll by rotating in a direction of the arrow 100 about an axis orthogonal to a plane of the first surface 233 of the porous substrate 234.

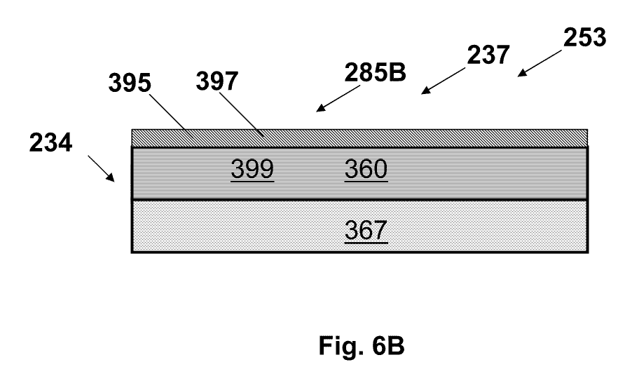

FIG. 5 depicts a longitudinal cross-sectional view of the apparatus taken along an axis 5-5 of FIG. 4. FIGS. 4-5 depict the particles 205 of reactive (polymerizable) thermoplastic or thermoset resin may advantageously be deposited onto the first surface 234 of the porous substrate 233, wherein the first surface 233 of the porous substrate 234 has been advantageously heated to at least 90° C. before the particles 205 being at ambient temperature have been deposited thereon.

FIG. 4 depicts an embodiment, in which the particles 205 of reactive (polymerizable) thermoplastic or thermoset resin may advantageously be deposited onto the first surface 233 of the porous substrate 234, wherein only the particles 205 are advantageously at ambient temperature, but the first surface 233 of the porous substrate 204 has been “pre-warmed”, to enable the particles 205 of the reactive (polymerizable) thermoplastic or thermoset resin to adhere “immediately” to the first surface 233 of the porous substrate 234. In the embodiments depicted in FIGS. 4-5, and described in associated text, infra, the inventors report prevention of “rolling away”, or “blowing away” of the particles 205 when they are deposited onto the first surface 233 of the porous substrate 234 by pre-warming the first surface 233 of the porous substrate 234.

The combined particle deposition and a thermal fixing stage 227 comprises: a first steel-net conveyor belt 217; at least one supply roll(s) 200 for supplying a porous substrate 234; at least one hopper(s) 225 being charged with particles 205 of reactive (polymerizable) thermoplastic or thermoset resin; a thermally fixed array of particles 235 of reactive (polymerizable) thermoplastic or thermoset resin deposited onto a first surface 233 of the porous substrate 234. The combined particle deposition and a thermal fixing stage 227 includes a pre-warming oven 207 for pre-warming the first surface 233 of the porous substrate 234, so a first portion the particles 205 may be thermally fixed to the first surface 233 of the porous substrate 234 when the particles 205 are randomly deposited on the first surface 233 of the porous substrate 234, so that the particles 205 may be thermally fixed as the array of particles 235. In this embodiment of the invention “rolling away”, or “blowing away” of the particles 205 is prevented when the particles 205 are deposited onto the first surface 233 of the porous substrate 234 by pre-warming the first surface 233 of the porous substrate 234.

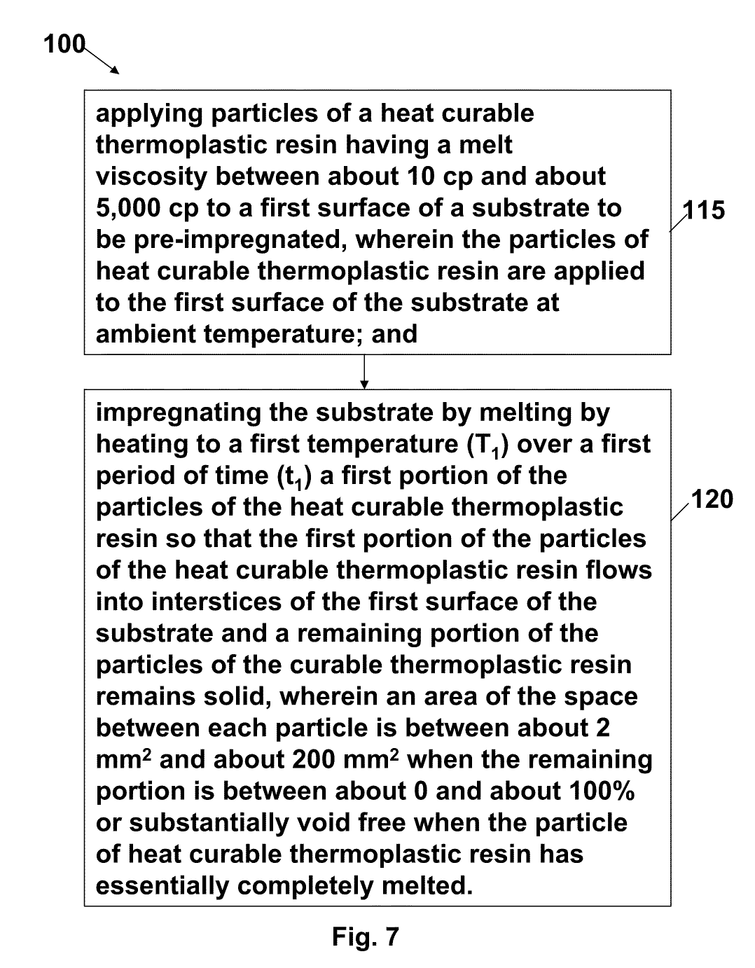

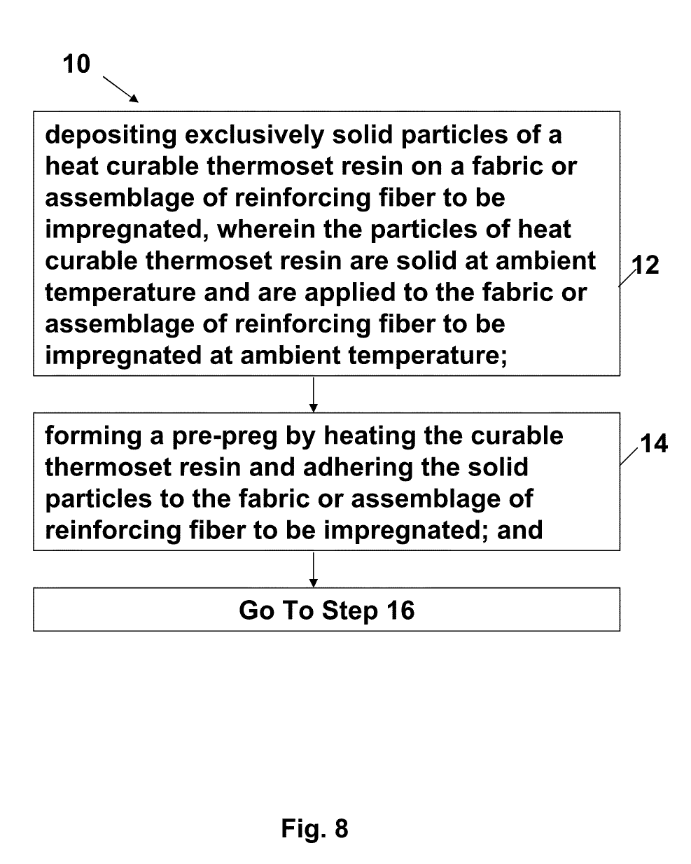

A range of particle size distribution of the particles 205 of reactive (polymerizable) thermoplastic or thermoset resin may advantageously be greater than the range of particle size distribution of powders used in certain powder impregnation methods for infusing reactive (polymerizable) thermoplastic powders into the interstices 295 between fibers 221 or fiber bundles of the porous substrate 234, as depicted in FIGS. 5, 6A, and 6B and described in associated text herein. In one embodiment, the particles 205 of the reactive (polymerizable) thermoplastic or thermoset resin may advantageously be greater than between 150 to 1000 μm. In one embodiment the particles 205 of the reactive (polymerizable) thermoplastic or thermoset resin may advantageously have a diameter ranging from between 2 to 5 mm.

The prepreg finishing stage 229 comprises: a second steel-net conveyor belt 223 for picking up the porous substrate 234 having the thermally fixed array of particles 235 of reactive (polymerizable) thermoplastic or thermoset resin, thereon, from the first steel-net conveyor belt 217 to convey the thermally fixed array of particles 235 into oven 209. The oven 209 may provide hot air laminar flow 213 to the porous substrate 234 having the thermally fixed array of particles 235 of the reactive (polymerizable) thermoplastic or thermoset resin thereon and to the second steel net conveyor 223. The oven 209 may be any appropriate heating device capable of raising the temperature of the porous substrate 234 between about 190° C. and 220° C. in a residence time between about 1 and about 5 minutes. In one embodiment, the porous substrate 234 is a fiber reinforcement fabric, a glass mat, or a fiber bed.

The first and second steel-net conveyor belts 217, 223 may be supported by legs 245 that rest on manufacturing floor 239. The first and second steel-net conveyor belts 217, 223 may rotate in a direction of the arrow 60 to carry the porous substrate 234 having the thermally fixed array of particles 235 of reactive (polymerizable) thermoplastic or thermoset resin, thereon, from the first steel-net conveyor belt 217 to convey the thermally fixed array of particles 235 into oven 209.

The prepreg retrieval stage 237 comprises: a retrieving roll 215 for retrieving the prepreg 285; a prepreg 285, wherein the prepreg 285 comprises the porous substrate 234 from supply roll 200, and a thermally fixed particle array 231, thereon. The at least one retrieving roll(s) 215 may retrieve the prepreg 285 by rotating in a direction of the arrow 65 about an axis orthogonal to a plane of the first surface 233 of the porous substrate 234.

FIG. 5 depicts a longitudinal cross-sectional view of the combined particle deposition and a thermal fixing stage 227 of the apparatus 253 taken along an axis 5-5 of FIG. 4. FIG. 5 depicts a thermally fixed particle array 235. The prepreg 285 is drapable because the array 235 of thermally fixed particles 205 may be thermally fixed by partially melting the particles 205 of reactive (polymerizable) thermoplastic or thermoset resin which partially melt when the particles 205 touch or undergo heat transfer from the pre-warmed first surface 233 of the porous substrate 234. The melt from the partially melted reactive (polymerizable) thermoplastic or thermoset resin particles 205, shown in FIG. 5, may flow into the interstices 295 between the fibers 221 or fiber bundles of the porous substrate 234, resulting in the particles 205 becoming thermally fixed to the fibers 221 or fiber bundles in the first surface 233 of the porous substrate 234 when the reactive (polymerizable) thermoplastic or thermoset resin crystallizes or resolidifies when the thermally fixed particle array 235 cools below the melting point of the reactive (polymerizable) thermoplastic or thermoset resin after coming out of oven 207 of the combined particle deposition and thermally fixing stage 227. The prepreg 285 may be drapable because the array 235 of thermally fixed particles 205 are thermally fixed to the first surface 233, thereon, and separated by spaces 250.

FIG. 6A depicts a longitudinal cross-sectional view of the particle prepreg retrieval stage 237 of the apparatus 253 taken along an axis 6A-6A of FIG. 4. FIG. 6A depicts a drapable prepreg 285, having a thermally fixed particle array 235. The prepreg 285A is drapable because the array 235 of thermally fixed particles 205 may be thermally fixed by partially melting the particles 205 of reactive (polymerizable) thermoplastic or thermoset resin which partially melt when the particles 205 touch or undergo heat transfer from the pre-warmed first surface 233 of the porous substrate 234. The melt from the partially melted reactive (polymerizable) thermoplastic or thermoset resin particles 205, shown in FIG. 5, may flow into the interstices 295 between the fibers 221 or fiber bundles of the porous substrate 234, resulting in the particles 205 becoming thermally fixed to the fibers 221 or fiber bundles in the first surface 233 of the porous substrate 234 when the reactive (polymerizable) thermoplastic or thermoset resin crystallizes or resolidifies when the thermally fixed particle array 235 cools below the melting point of the reactive (polymerizable) thermoplastic or thermoset resin after coming out of oven 207 of the combined particle deposition and thermally fixing stage 227. The prepreg 285 may be drapable because the array 235 of thermally fixed particles 205 are thermally fixed to the first surface 233, thereon, and separated by spaces 250.

FIG. 6B depicts a longitudinal cross-sectional view of the particle prepreg retrieval stage 237 of the apparatus 253 taken along an axis 6B-6B of FIG. 4. The prepreg 285B, shown in FIG. 6B, may be non-drapable because an at least one layer(s) 397, 360 of reactive (polymerizable) thermoplastic or thermoset resin have been formed that do not have voids. In one embodiment, the reactive (polymerizable) particles 205, shown in FIGS. 4-5, have been completely melted to form a layer 397 of reactive (polymerizable) thermoplastic or thermoset resin. A portion 399 of the layer 397 may be impregnated or impressed into the interstices 295 between fibers 221 or fiber bundles of the porous substrate 234, shown in FIGS. 4, 6A may form a layer 360, in which the reactive (polymerizable) thermoplastic or thermoset resin has been thermally fixed onto the fibers 221 or fiber bundles and filled into the spaces 255 between the particles 365 of the array 235, shown in FIG. 6A, have flowed together to become the layer 360. In another embodiment, the completely melted reactive (polymerizable) thermoplastic or thermoset resin layer 97 has melted and extends essentially completely into the substrate 234, forming the layer 360 and 367 in the substrate 234. Hereinafter, “thermally fixed” means reactive functionalities of the reactive (polymerizable) thermoplastic or thermoset resin particles 205 have become chemically bonded or attracted by Van der Wahls forces or other attractive intermolecular forces to the fibers 221 or fiber bundles of the substrate 234 during the melting process. FIG. 6B depicts a prepreg 285B that is non-drapable because a first portion 399 of the completely melted reactive (polymerizable) thermoplastic or thermoset resin 397 has flowed into interstices 295 between fibers 221 or fiber bundles of the porous substrate 234, so that some of the melt impregnates or impresses between and among the fibers 221 or fiber bundles of the porous substrate 234, forming at least one layer 360, 367 of reactive (polymerizable) thermoplastic or thermoset resin in the porous substrate 234. A remaining portion 395 of the completely melted reactive (polymerizable) thermoplastic or thermoset resin that doesn't flow into the interstices between fibers or fiber bundles of the porous substrate 234 forms the layer 397 which lies upon the first surface 233 of the porous substrate 234.

Void free laminates or composite structures may be made from drapable or non-drapable reactive (polymerizable) polymer pre-impregnated reinforcement materials (prepregs) 285A, B. The non-drapable reactive (polymerizable) polymer pre-impregnated reinforcement materials (prepregs) 285A may be an at least one layer(s) 97,19, and/or 13, as in FIG. 3B or 397, 360, and/or 367, as in FIG. 6B, of low melt viscosity reactive (polymerizable) thermoplastic or thermoset resin particles 4, 205, having been completely melted when thermally fixed or compression molded. The combination of heat and pressure may force the low viscosity reactive (polymerizable) thermoplastic or thermoset resin to penetrate the fibers 95, 221 through the porous substrate 8, 234.

Reactive (polymerizable) thermoplastic composite pre-pregs 28A, B, 285A, B and thermoplastic based fully polymerized sheets may be manufactured from powdered macrocyclic polyester oligomers using powder impregnation, or solvent or slurry based impregnation, or hot melt impregnation technologies. However, powder impregnation, or solvent or slurry based impregnation, or hot melt impregnation technologies are undesirable for the following reasons.

Using powders as precursor material is expensive, since grinding of typically available granules is an additional production step, which in the case of polyesters and polyamides has to happen under cryogenic temperatures. Also, powder impregnation followed by melting the powder forms a continuous thermoplastic layer that is not drapable.

Using solvent or slurry based methods have issues with evaporating the slurry carrier or solvent during the process, making these methods highly complicated and expensive.

Using hot melt technologies requires the use of complex melting, dosing and delivering systems such as extruders and rotoformers and also have the problem of having to initiate an advanced polymerization inside the delivery equipment before impregnating the fiber bed.

Therefore, there has been a long felt need for a process for making the pre-pregs 28A, B, 285A, B and thermoplastic based fully polymerized sheets that do not require powder impregnation, or solvent or slurry based impregnation, or hot melt impregnation technologies, in which low melt viscosity reactive (polymerizable) thermoplastic or thermoset resins particles 4, 205 are directly deposited onto a first surface 17, 233 of a porous substrate 8, 234 of the -pregs 28A, B, 285A, B and thermoplastic based fully polymerized sheets, thereon. In this process, which is an alternative to powder impregnation, or solvent or slurry based impregnation, or hot melt impregnation technologies, direct deposition of the low melt viscosity reactive (polymerizable) thermoplastic or thermoset resin particles 4, 205 onto the first surface 17, 233 of the porous substrate 8, 234 thereon, is followed by impregnating or impressing a portion or all of the low melt viscosity particles 4, 205 into the fibers or fiber bundles 95, 221 of the porous substrate 8, 234 by melting the reactive (polymerizable) thermoplastic or thermoset resin particles 4, 205 and optionally applying pressure. A process requiring that only ambient temperature resin particles 4, 205 be directly deposited onto the first surface 17, 233 of the porous substrate 8, 234 is preferred over processes requiring the reactive (polymerizable) thermoplastic or thermoset resin particles 4, 205 to be melted, slurried, commingled, or diluted with solvents, fillers, or plasticizers, before being deposited, because it is less expensive by avoiding these steps. Reactive (polymerizable) thermoplastic or thermoset resin particles 4, 205 having melt viscosities between about 5 cp and about 5,000 cp before being cured (polymerized) are commercially available from the Cyclics Corporation, Schenectady, N.Y. 12308, USA. CBT® 100 and CBT® 200 melt to water-like viscosity when heated, then polymerize into engineering thermoplastic PBT when catalyzed. CBT 100 features processing temperature between 190-240° C., while CBT 200 ranges from 170-240° C. Melting the particles 4, 205 before depositing the reactive (polymerizable) thermoplastic or thermoset resin particles 4 onto the first surface 17, 233 of the porous substrate 8, 234 has been used when it is necessary to melt thermoplastic or thermoset resins having higher melt viscosities than 5,000 cp in order to ensure the higher melt viscosity thermoplastic or thermoset resins come in close contact with the first surface 17, 233 of the porous substrate 8, 234 and the fibers and fiber bundles 95, 221 therein, such as a fiber bed before consolidation.

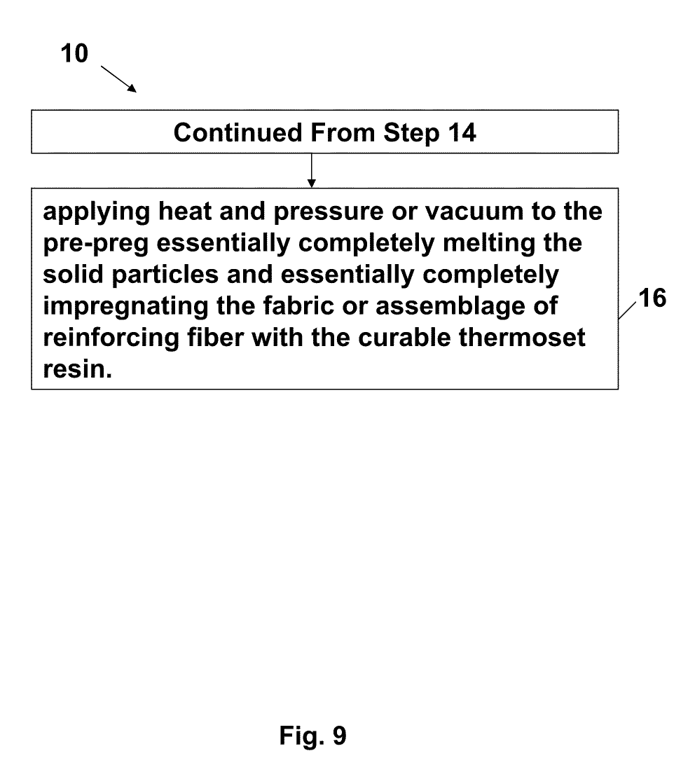

FIG. 7 depicts a flow sheet for a method 100 for making a reactive (polymerizable) polymer pre-impregnated reinforcement material. In a step 115 of the method 100 a reactive (polymerizable) thermoplastic or thermoset resin having a melt viscosity between about 5 cp and about 5,000 cp is applied to a first surface 117 of a porous substrate 8 to be pre-impregnated.

In one embodiment of the step 115 of the method 100, particles 4 of the heat curable thermoplastic or thermoset resin may be deposited onto the first surface 117 of the porous substrate 8 at ambient temperature from a hopper 10, such as a solid particle feeder.

In a step 120 of the method 100, the reactive (polymerizable) thermoplastic or thermoset resin is thermally fixed into interstices of the first surface of the porous substrate by partially melting a first portion of the curable thermoplastic or thermoset resin by heating to a first temperature T₁ over a first period of time t₁ so that the first portion of the reactive (polymerizable) thermoplastic flows into interstices of the porous substrate and a remaining portion of the curable thermoplastic or thermoset resin remains solid.

Fiber-reinforced plastic materials such as fiber-reinforced composites or fiber-reinforced laminates may be manufactured by first forming a reactive (polymerizable) polymer pre-impregnated reinforcement material (a “prepreg”), as in the method 100. In the method 100, the prepreg is formed by impregnating a fiber reinforcement material with a reactive (polymerizable) thermoplastic or thermoset resin.

In one embodiment, the method 100 may comprise a consolidating step 115, in which a plurality of prepregs are consolidated into a laminate, such as a reactive (polymerizable) thermoplastic or thermoset resin composite sheet. Fiber-reinforced plastic materials based on polyesters and nylon materials may be manufactured by first impregnating the fiber reinforcement with the thermoplastic or thermoset resin to form a prepreg, then consolidating one, two or more of the same into a laminate, like a thermoplastic composite sheet. In the consolidating step, consolidating may be necessary to fully impregnate the fiber reinforcement material, which may be laid out as a multi-layered bed before impregnation.

In one embodiment of the consolidating step of the method 100, the prepregs may be consolidated by applying heat and pressure. Higher temperatures and pressures are required to achieve substantially void free laminates by consolidation if the melt viscosity of the reactive (polymerizable) thermoplastic or thermoset resin is greater than between about 5 cp to about 5,000 cps.

Reactive (polymerizable) thermoplastic or thermoset resins having melt viscosities between about 5 cp and about 5,000 cp before being cured are commercially available from the Cyclics Corporation, Schenectady, N.Y. USA. Having a very low melt viscosity during processing, enables the reactive (polymerizable) thermoplastic or thermoset resins to impregnate a dense fibrous preform or bed more easily. Upon melting and in the presence of an appropriate catalyst, polymerisation occurs and the reactive (polymerizable) thermoplastic cures to form the laminate.

In one embodiment of the method 100, the reactive (polymerizable) thermoplastic or thermoset resin may be a blend of a polymerization catalyst and a linear polyester or a linear polyamide, wherein the polymerization catalyst is chosen so that the melt viscosity of the thermoplastic or thermoset resin characterizes its viscosity during the heating and impregnation steps 117, 120 of the method 100 to impregnate the reactive (polymerizable) thermoplastic or thermoset resin into the fiber reinforcement material.

In one embodiment of the method 100, the reactive (polymerizable) thermoplastic or thermoset resin may be a blend of a polymerization catalyst and a linear poly alkylene terephthalate (where the alkylene has between about 2 and about 8 carbon atoms) or a linear poly alkylene amide (where the alkylene has between about 4 and about 12 carbon atoms).

In one embodiment of the method 100, the reactive (polymerizable) thermoset resin may be an epoxy resin system such as a bifunctional epoxy (diglycidyl ether of bisphenol-A) matrix system.

In one embodiment of the method 100, the reactive (polymerizable) thermoset resin may be a reactive (polymerizable) unsaturated polyester resin or epoxy resin. Unsaturated polyester resins (USR) are the third-largest class of thermoset molding resins. The polyesters are low molecular weight viscous liquids dissolved in vinyl monomers like styrene to facilitate molding or shaping of the resin into a desired form before curing to rigid solids. Typical applications are in fiberglass-reinforced shower stalls, boat hulls, truck caps and airfoils, construction panels, and autobody parts and trim. Mineral-filled UPRs are used in synthetic marble countertops and autobody putty. Unfilled UPRs are used in gel coats and maintenance coatings. Adipic acid improves tensile and flexural strength in these resins and, at high levels, can give soft, pliable products for specialty applications. 1-Alkyd resins, a common type of unsaturated polyester resin, utilize adipic acid where low viscosity and high flexibility are valued in plasticizer applications. UPR resins are mainly aromatic polyesters. Flexibility of UPR is increased by replacing a portion of aromatic acid with adipic acid. A cure site monomer, like maleic anhydride, is incorporated to provide unsaturation within the polymer backbone. Crosslinking is by free radical addition polymerization of styrene monomer/diluent.

In one embodiment of the method 100, the reactive (polymerizable)thermoplastic or thermoset resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment of the method 100, the fiber reinforcement material may be carbon fiber, glass fiber, basalt fiber, aramid fiber, steel fiber, natural fiber, polymer fiber, and combinations thereof.

In a step 120 of the method 100, the reactive thermoplastic or thermoset resin is thermally fixed into interstices of the first surface of the porous substrate.

In the step 120, a first portion of the curable thermoplastic or thermoset resin is partially melted by heating to a first temperature T₁ over a first period of time t₁ so that the first portion of the reactive thermoplastic flows into interstices of the porous substrate and a remaining portion of the curable thermoplastic or thermoset resin remains solid.

In one embodiment of the method 100, a shape of the thermoplastic or thermoset resin is selected from the group consisting of a granule, pellet, flake, pastille, needle, chunks, and a chip.

In one embodiment of the method 100, the porous substrate is a reinforcement material selected from the group consisting of carbon fiber, glass fiber, basalt fiber, aramid fiber, steel fiber, natural fiber, polymer fiber and combinations thereof.

In one embodiment of the method 100, the reinforcement material is in a form selected from the group consisting of roving, tape, web, weave, bi- or -multi-axial fabrics, knit, braid, random mat, and fleece.

In the step 120, in one embodiment, the first temperature is between about 190° C. and about 220° C. and the first period of time is between about 1 and 5 minutes.

In one embodiment of the method 100, a weight of the reinforcement material per surface area of the reinforcement material is between about 200 g/m² and about 4,000 g/m² and a weight percent of the reactive thermoplastic is between about 30% to about 80%, based on a weight of the reactive polymer pre-impregnated reinforcement material.

Hereinafter a reactive (polymerizable) thermoplastic or thermoset resin particle loading of 100 g/mm² equals 70 wt % on a 460 g/mm² GF fabric (the granule size needs to become smaller and smaller). 1000 g/mm² equals 30 wt % on a 810 g/mm² GF Fabric, respectively 38 wt % on a 810 g/mm² CF fabrc. This is always meant to be for “one layer per substrate”. 1700 g/m² for 4× layers of 810 g/m² GF; considering even fiber volume fraction as low as 30% up to 4000 g/m² resin have to be deposited.

In the step 120, in one embodiment, the first temperature is 190° C. and the first time period is less than or equal to 1 minute.

In one embodiment of the method 100, a weight of the reinforcement material per surface area of the reinforcement material is about 460 g/m² and a weight percent of the reactive thermoplastic is between about 34% to about 35%, based on a weight of the reactive polymer pre-impregnated reinforcement material.

In one embodiment of the method 100, a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

In one embodiment of the method 100, a weight of the reinforcement material per surface area of the reinforcement material is about 810 g/m² and a weight percent of the reactive thermoplastic is between about 34% to about 36%, based on a weight of the reactive polymer pre-impregnated reinforcement material.

In one embodiment, the drapable polymer pre-impregnated reinforcement material pre-preg 28A, 285A comprises: a porous substrate 8, 234 having a first surface 17, 231; randomly spaced particles 4, 205 of a reactive thermoplastic, thereon, wherein a portion 99, 399 of each of the randomly spaced particles 4, 205 is impregnated into interstices 93, 295 of the first surface 17, 231 of the reinforcement material, therein, and wherein a space 11, 50 therebetween, separates adjacent randomly spaced particles 4, 205.

In one embodiment of the drapable polymer pre-impregnated reinforcement material (pre-preg) 28A, 285A, the reactive thermoplastic particles have a melt viscosity between about 5 cp and about 5,000 cp.

In one embodiment of the drapable polymer pre-impregnated reinforcement material (pre-preg) 28A, 285A, an area of the space between each particle is between about 2 mm² and about 200 mm².

In one embodiment of the drapable polymer pre-impregnated Reinforcement material (pre-preg) 28A, 285A the particles have a diameter between about 1 mm to about 5 mm and a length between about 1 mm and about 8 mm.

In one embodiment of the drapable polymer pre-impregnated reinforcement material (pre-preg) 28A, 285A the particles have a thickness between 0.5 mm and 3 mm and a diameter between 1 mm and about 8 mm.

In one embodiment of the drapable polymer pre-impregnated reinforcement material (pre-preg) 28A, 285A the particles have a diameter between about 1 mm to about 8 mm and a length between about 1 mm and about 8 mm.

In one embodiment of the drapable polymer pre-impregnated reinforcement material (pre-preg) 28A, 285A the particles are made from macrocyclic oligomeric butyleneterephthalate.

In one embodiment of the drapable polymer pre-impregnated reinforcement material (pre-preg) 28A, 285A the particles have a diameter between about 1 mm and about 5 mm and a length between about 1 mm and about 8 mm.

In one embodiment, a method for forming a drapable polymer pre-impregnated reinforcement material (pre-preg) 28A, 285A, comprises: providing a porous substrate 8, 234 having a first surface 17, 231; and thermal fixing an array 9, 235 of essentially randomly spaced particles 4, 205 of a reactive thermoplastic having a melt viscosity between about 5 cp and about 5,000 cp., thereon.

An apparatus 200, 253 for forming a drapable or non drapable polymer pre-impregnated reinforcement material (pre-preg), comprising: at least one feeder device 20, 200 of reinforcement material 8, 234; at least one receiver device 25, 215 of polymer pre-impregnated reinforcement material 8, 234; and at least one conveyor belt(s) 14, 15, 217, 223 having the reinforcement material 8, 234 from the at least one feeder device(s) 20, 200 thereon; a particle deposition hopper 10, 225 charged with reactive thermoplastic particles 4, 205 and adapted to deposit between 100 g/m² and about 1000 g/m² of the reactive thermoplastic particles 4, 205, based on the surface area (m²) of the reinforcement material 8, 234; at least one heating unit oven 5, 209 adapted to substantially uniformly maintain a temperature of the reactive thermoplastic particles 4, 205 on a first surface 17, 231 of the reinforcement material 8, 234 for a residence time, during which the reactive thermoplastic particles 4, 205 on a first surface 17, 231 of the reinforcement material 8, 234 reside in the oven 5, 209; and at least one conveyor belt(s) 14, 15, 217, 223 wherein residence time that the reactive thermoplastic particles 4, 205 on the first surface 17, 231 of the reinforcement material 8, 234 is based on the conveyor belt's 14, 15, 217, 223 rate.

In one embodiment of the apparatus 200, 253 for forming a drapable or non drapable polymer pre-impregnated reinforcement material (pre-preg) 28A, B, 285A, B, the conveyor belt's 14, 15, 217, 223 rate is between about 1 meters per minute and about 4 meters per minute.

In one embodiment of the apparatus 200, 253 for forming a drapable or non drapable polymer pre-impregnated reinforcement material (pre-preg) 28A, B, 285A, B, the residence time that the reactive thermoplastic particles 4, 205 on a first surface 17, 231 of the reinforcement material 8, 234 reside in the oven 5, 209 is between about 1 min. and about 5 min.

In one embodiment of the apparatus 200, 253 for forming a drapable ornon drapable polymer pre-impregnated reinforcement material (pre-preg), the reactive thermoplastic material is selected from the group consisting of reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment of the apparatus 200, 253 for forming a drapable ornon drapable polymer pre-impregnated reinforcement material (pre-preg) 28A, B, 285A, B, a shape of the thermoplastic or thermoset resin is selected from the group consisting of a granule, pellet, flake, pastille, needle, chunks, and a chip.

In one embodiment of the apparatus 200, 253 for forming a drapable ornon drapable polymer pre-impregnated reinforcement material (pre-preg) 28A, B, 285A, B, the porous substrate is a reinforcement material selected from the group consisting of carbon fiber, glass fiber, basalt fiber, aramid fiber, steel fiber, natural fiber, polymer fiber, and combinations thereof.

In one embodiment of the apparatus 200, 253 for forming a drapable or non drapable polymer pre-impregnated reinforcement material (pre-preg) 28A, B, 285A, B, the reinforcement material 8, 234 is in a form selected from the group consisting of roving, tape, web, weave, bi- or -multi-axial fabrics, knit, braid, random mat, and fleece.

In one embodiment of the apparatus 200, 253 for forming a drapable or non drapable polymer pre-impregnated reinforcement material (pre-preg) 28A, B, 285A, B, the temperature is between about 190° C. and about 220° C. and the residence time is between about 1 and 5 minutes.

In one embodiment of the apparatus 200, 253 for forming a drapable ornon drapable polymer pre-impregnated reinforcement material (pre-preg) 28A, B, 285A, B, a weight of the reinforcement material per surface area of the reinforcement material is between about 200 g/m² and about 2,000 g/m² and a weight percent of the reactive thermoplastic is between about 30% to about 80%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, the temperature is 190° C. and the residence time is less than or equal to 1 minute.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 460 g/m² and a weight percent of the reactive thermoplastic is between about 34% to about 35%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 620 g/m² and a weight percent of the reactive thermoplastic is between about 33% to about 36%, based on a weight of the reactive polymer pre-impregnated reinforcement materials.

In one embodiment of the apparatus 200, 253 for forming a drapable or non drapable polymer pre-impregnated reinforcement material (pre-preg) 28A, B, 285A, B, a weight of the reinforcement material per surface area of the reinforcement material is about 810 g/m² and a weight percent of the reactive thermoplastic is between about 34% to about 36%, based on a weight of the reactive polymer pre-impregnated reinforcement material.

In one embodiment of the apparatus 200, 253 for forming a drapable or non drapable polymer pre-impregnated reinforcement material (pre-preg) 28A, B, 285A, B, the reactive thermoplastic particles 4, 205 have a thickness between 0.5 mm and 3 mm and a diameter between 1 mm and about 8 mm.

In one embodiment of the apparatus 200, 253 for forming a drapable ornon drapable polymer pre-impregnated reinforcement material (pre-preg) 28A, B, 285A, B, the reactive thermoplastic particles 4, 205 have a diameter between about 1 mm to about 8 mm and a length between about 1 mm and about 8 mm.

In one embodiment of the apparatus 200, 253 for forming a drapable or non drapable polymer pre-impregnated reinforcement material (pre-preg) 28A, B, 285A, B, the reactive thermoplastic particles 4, 205 are made from macrocyclic oligomeric butyleneterephthalate.

In one embodiment of the apparatus 200, 253 for forming a drapable or non drapable polymer pre-impregnated reinforcement material (pre-preg) 28A, B, 285A, B, the reactive thermoplastic particles 4, 205 have a diameter between about 1 mm and about 5 mm and a length between about 1 mm and about 8 mm.

In one embodiment of the apparatus 200, 253 for forming a drapable or non drapable polymer pre-impregnated reinforcement material (pre-preg) 28A, B, 285A, B, comprises: a belt press 407 after the heating unit oven 5, 209, wherein the belt press 407 has a hot zone and a cold zone, wherein the hot zone is adapted to receive drapable polymer pre-impregnated reinforcement material and to heat said pre-impregnated reinforcement material to less than or equal to 250° C. and greater than or equal to 0.01 bar pressure, and wherein the cold zone is adapted to receive a fully impregnated and cured thermoplastic composite sheet and to cool said fully impregnated and cured thermoplastic composite sheet to 25° C.

In one embodiment, a method for forming a thermoplastic composite sheet 28B, 285B, comprises: providing a feeder roll 20, 200 of reinforcement material 8, 234, a receiver roll 25, 215 of drapable polymer pre-impregnated reinforcement material 8, 234 and a conveyor belt 14, 217 having the reinforcement material 8, 234 from the feeder roll 20, 200 thereon, wherein the reinforcement material 8, 234 has a fiber content based on total weight of the thermoplastic composite sheet; providing a particle deposition unit 10, 225 charged with reactive thermoplastic particles 4, 205 and adapted to deposit between 240 g/m² and about 470 g/m² of the reactive thermoplastic particles 4, 205, based on the surface area (m²) of the reinforcement material 8, 234;

In one embodiment, a method for forming a thermoplastic composite sheet 28B, 285B, comprises: providing a heating unit 5, 209 adapted to substantially uniformly maintain the reactive thermoplastic particles 4, 205 on a first surface 17, 231 of the reinforcement material 8, 234 between about 190° C. and about 220° C. during a residence time that the reactive thermoplastic particles 4, 205 on a first surface 17, 231 of the reinforcement material 8, 234 reside in the oven 5, 209.

In one embodiment, a method for forming a thermoplastic composite sheet 28B, 285B, comprises: providing a conveyor belt 14, 217 wherein residence time that the reactive thermoplastic particles 4, 205 on the first surface 17, 231 of the reinforcement material 8, 234 is based on the conveyor belt's 14, 217 rate; and providing a belt press 407 after the heating unit 5, 209, wherein the belt press 407 has a hot zone and a cold zone, wherein the hot zone is adapted to receive drapable polymer pre-impregnated reinforcement material 28B, 285B and to heat said pre-impregnated reinforcement material 28B, 285B to less than or equal to 250° C. and greater than or equal to 0.01 bar pressure, and wherein the cold zone is adapted to receive a fully impregnated and cured thermoplastic composite sheet and to cool said fully impregnated and cured thermoplastic composite sheet to 25° C.

In one embodiment of the method for forming a thermoplastic composite sheet 28B, 285B, the fiber content of the reinforcement material 8, 234 is between about 50% and about 70% by weight, based on a weight of the drapable polymer pre-impregnated reinforcement material 28B, 285B.

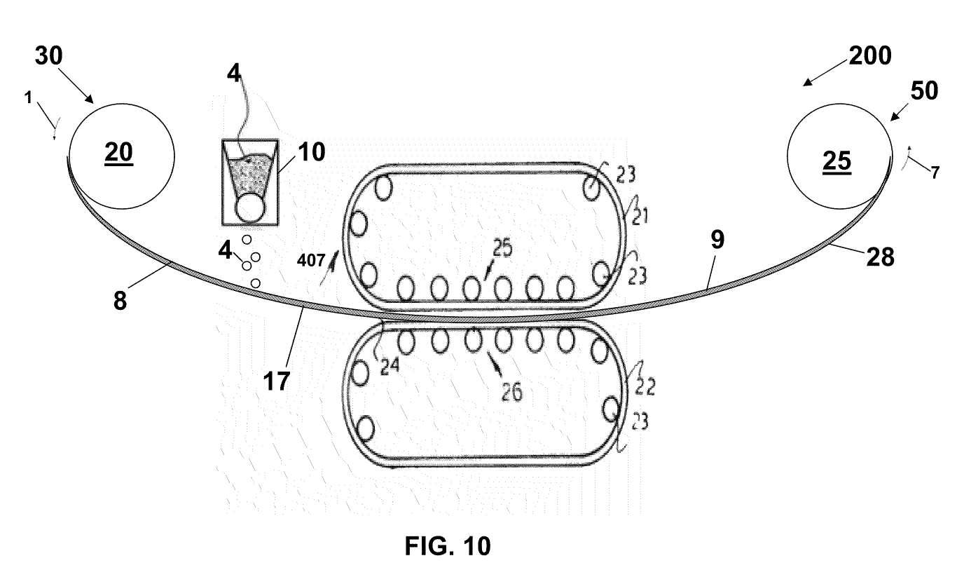

FIGS. 8-9 depict a flow sheet diagram of a method 10 for manufacturing “pre-pregs”. Hereinafter, a “pre-preg” is defined as fiber reinforced sheets impregnated with a thermosetting resin which may be subsequently cured to form a thermoset composite sheet. A pre-preg is also defined as a reactive polymer pre-impregnated reinforcement material from thermosets. The fibers could be, but are not exclusively, glass fiber, carbon fiber, steel fibers, aramid fibers, basalt fiber, polymer fiber, natural fibers, or combinations thereof.

Thermoset resins and thermoplastic resins suited for preparing pre-pregs from the substantially non-volatile composition 4 may have a melt viscosity between about 5 cps and about 5,000 cps such as: epoxy resins, unsaturated polyester resins, vinyl ester resins, thermoset polyurethane resins, phenol-formaldehyde resins (phenolic resins), polyimide resins, silicone resins, crosslinkable thermoplastic resins, e.g., crosslinkable polyethylene resins, crosslinkable polypropylene resins, crosslinkable polymers, crosslinkable polymers, and crosslinkable polyvinyl chloride resins. The substantially non-volatile composition 4 comprises thermoset resins that are substantially completely solid at ambient temperature, i.e. 40° C. The only volatile components in the substantially non-volatile composition 4 are residual solvents or water. A comprehensive listing of thermoset resins may be found in “Handbook of Thermoset Resins,” 2^{nd} Edition, by Sidney H. Goodman, Noyes Publications, Westwood, N.J., ISBN: 0-8155-1421-2 (1998), which is hereby incorporated by reference

This list is not meant to be limiting or exhaustive but merely illustrates the wide range of polymeric materials which may be employed in the present invention. Thermoset resins of the present invention may be epoxy based or unsaturated polyester based that are also solid at room temperature. The resins are substantially completely solid at room temperature and are deposited in their solid form on the fibers. The resins are generally particles having powder, granules, pellets, pastilles, flakes, chips, or any other suitable solid form. Depositing the thermoset resins in their solid form, instead of their molten liquid form is advantageous because solids are easier to deposit on the fiber mat than molten liquids. FREOPOX resin, available from Freilacke and RESICOAT resin available from AKZO NOBEL are examples of suitable resins.

The method 10 comprises the following steps. In a step 12, a thermosetting resin, substantially completely in its solid form, e.g. as a powder, is deposited on a fabric or assemblage of reinforcing fiber. The thermoset resin is in its solid form at ambient temperature. The resin may be dried to remove moisture or solvent prior to depositing the resin on the fabric or assemblage of reinforcing fiber to avoid voids in the formed pre-preg.

In one embodiment of the step 12 of the method 10, the resin can be pre-catalyzed and have a long shelf life because it is solid at room temperature.

In one embodiment of the step 12 of the method 10, solid resins can be in the form of powders, granules, pellets, pastilles, flakes, chips, or any other suitable solid form.

In one embodiment of the step 12 of the method 10, the resin can be uniformly deposited with a particle deposition unit 10, 225, e.g., a powder sprinkling device. Schott & Meissner powder sprinkler from textile industry is an example of an appropriate powder sprinkling device which typically costs approximately 50-80,000 euro for a 3 m wide sprinkler. In one embodiment, the particle deposition unit is a powder sprinkling device and a field of deposition of the sprinkling device is from about 0 to about 4.0 m wide

In a step 14, a “pre-preg” is formed by heating the fabric or assemblage of reinforcing fiber, melting the resin so that it adheres to the fabric or assemblage of reinforcing fiber, and possibly impregnates the fiber or assemblage of reinforcing fiber with the heat curable thermoset resin. The pre-preg may then be stored for later use.

In a step 16, applying heat and pressure or vacuum to the pre-preg essentially completely melts the solid particles and essentially completely impregnates the fabric or assemblage of reinforcing fiber with the heat curable thermoset resin and may cure the resin if it was pre-catalyzed.

In the steps 14-16 of the method 10, processing is faster than thermoplastic processing because the melt viscosity of the thermoset resin is lower viscosity than the melt viscosity of a thermoplastic when melted and can wet fibers quickly.

In one embodiment, the step 16 includes curing in a low pressure double belt press 407.

In one embodiment, the step 16 includes curing in a vacuum bagging process.

In one embodiment, the step 16 includes curing in a heated press.

In one embodiment, the step 16 includes curing in a vacuum bagging process.

Being able to use a thermoset resin in its solid form enables advantageously using a particle deposition unit 10, 225, e.g. a powder sprinkling device in the step 12-14 of the method 10.

Being able to use a thermoset resin in its solid form offers several advantages. First, thermoset resins typically have a lower melt viscosity than alternative thermoplastic resins which are also used to make pre-pregs and cured composite sheets. Lower temperatures and pressures are required to impregnate a fiber mat with the thermoset resin because thermoset resins typically melt at a lower temperature than thermoplastics and have a lower melt viscosity. Therefore a belt press 407, such as a double belt press used for impregnating the resin into the fiber mat in the step 16 of the method 10 may operate at a lower temperature and pressure when the resin is a thermoset rather than a thermoplastic.

Being able to use a thermoset resin in its solid form enables using equipment developed to make fiber reinforced thermoplastic sheets, consisting of a particle deposition unit 10, 225, e.g. a powder sprinkling device and a belt press 407, such as a double belt press. The double belt press can have a much lower operating pressure, and hence lower cost, than those developed for thermoplastics. In particular, the belt can be made of fiber reinforced plastic in place of steel.

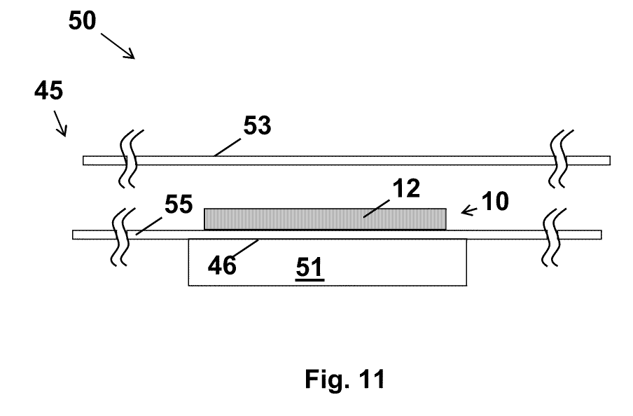

FIG. 10 is a schematic diagram illustrating a longitudinal cross-sectional view of an apparatus 200 for manufacturing a polymer pre-impregnated reinforcement material (prepreg) 28. The apparatus 200 comprises: a particle deposition stage 30, a belt press 407, such as a double belt press, and a prepreg retrieval stage 50.

The particle deposition stage 30 comprises: at least one supply roll(s) 20 for supplying a porous substrate 8; at least one hopper(s) 10 being charged with particles 4 of reactive (polymerizable) thermoset resin; an array of particles 4 of reactive thermoset resin deposited onto a first surface 17 of the porous substrate 8. The at least one supply roll(s) 20 may unroll by rotating in a direction of the arrow 1 and the receiving roll 25 may receive by rotating in a direction of the arrow 7 about an axis orthogonal to a plane of the at least one layer 17 of the porous substrate 8. The particles 4 of reactive (polymerizable) thermoset resin may advantageously be deposited onto the first surface 17 of the porous substrate 8, wherein both the particles 4 and the porous surface of the porous substrate 8 are advantageously at ambient temperature.

Referring first to FIG. 10, it can be seen that a belt press 407, such as a double belt press comprises a pair of belts 21 and 22 which are displaceable on rollers 23. The belts 21 and 22 define a pressing gap 24 between two arrays of support rolls 25 and 26.

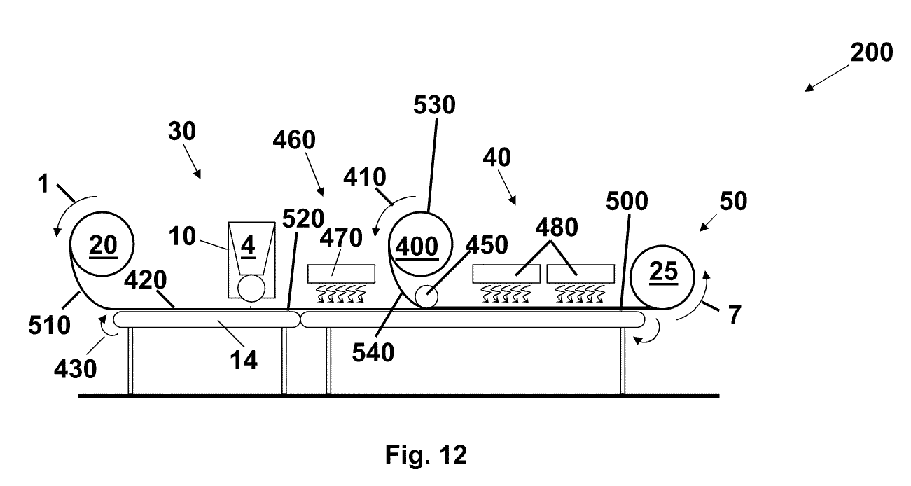

FIG. 11 depicts a cross-sectional view of an apparatus 50 for making a free form thermoset apparatus 10. The apparatus 50 comprises: a vacuum bag 45, an apparatus 10 in the vacuum bag 45, and a mold 51, having a first surface 46. The vacuum bag 45 comprises a plurality of vacuum bag sheets 53, 55. In one embodiment, the apparatus 50 for free-forming a shape of the apparatus 10, such as a composite assembly, comprises: a mold 51 having a first surface 46 and a vacuum bag 45 thereon, wherein the vacuum bag 45 comprises a plurality of vacuum bag sheet(s) 53, 55, and the apparatus 10 therein.

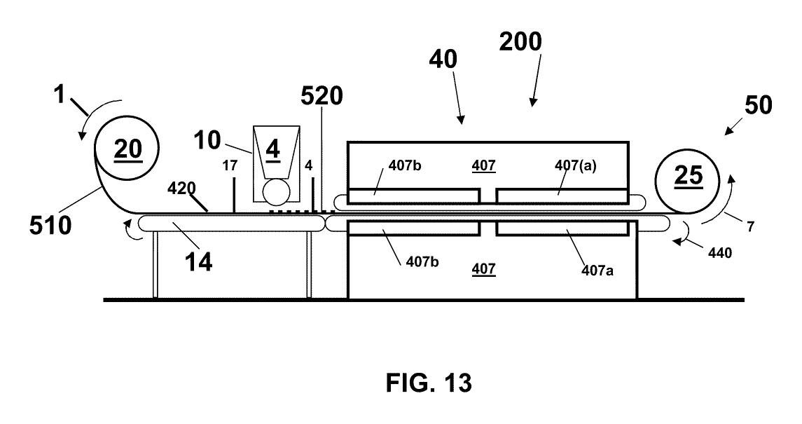

FIGS. 12-13 depict a schematic diagram illustrating a longitudinal cross-sectional view of an apparatus 200 for forming a thermoset composite sheet, comprises: at least one feeder roll 20, 400, wherein one of the feeder rolls 400 provides reinforcement material 510, a receiver roll 25 of drapable polymer pre-impregnated reinforcement material 500 and a conveyor belt 14 having the reinforcement material 510 from the feeder roll 20 thereon. The reinforcement material 510 has a fiber content based on total weight of the thermoset composite sheet made from curing the polymer pre-impregnated reinforcement material (prepreg) 500. The apparatus 200 for forming a thermoset composite sheet, comprises: a particle deposition hopper 10 charged with a substantially non-volatile composition 4, comprising a substantially completely solid reactive thermoset particles.

The substantially non-volatile composition 4 may also include non-volatile inorganic or thermoplastic fillers. The non-volatile inorganic fillers may be calcium carbonate, fumed silica, mined quartz, graphite, and the like. Thermoplastic fillers are selected from the group consisting of crosslinkable polyethylene resins, crosslinkable polypropylene resins, crosslinkable polyvinyl chloride resins, crosslinkable polymers, and combinations thereof. Thermoplastic fillers may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

FIG. 12 depicts the apparatus 200 for forming a thermoset composite sheet, comprises: at least one heating unit 470, 480, e.g. thermal convection oven, an infrared oven, a hot plate or other heating element, a heat exchanger for heating or cooling the particles of the substantially non-volatile composition 4 for a residence time for which the reactive thermoset particles reside on at least one layer 520 of the reinforcement material 510 in the heating unit 470, 480. The apparatus 200 for forming a thermoset composite sheet, comprises: a conveyor belt 14 wherein residence time that the particles of the substantially non-volatile composition 4 reside on the at least one layer 520 of the reinforcement material 510 is based on the conveyor belt's rate. The conveyor belt 14 rotates in a direction shown by the arrow 430 about an axis orthogonal to a plane of the at least one layer 520 of the reinforcement material 510.

In one embodiment, the particle deposition hopper 10 is adapted to deposit between 20 g/m² and about 2,000 g/m² of the particles of the substantially non-volatile composition 4, based on the surface area (m²) of the reinforcement material 510.

In one embodiment, FIG. 13 depicts apparatus 200 for forming a thermoset composite sheet, comprises: the belt press 407, at thermal fixing stage 40, is adapted to melt the substantially completely solid particles of the substantially non-volatile composition 4 on the at least one layer 520 of the reinforcement material 530 in a temperature range between about 40° C. and about 230° C.

In one embodiment, the hot zone, optionally 407a or 407b, of the belt press 407, depicted in FIGS. 1, 10, and 13, and described herein, is adapted to receive the reinforcement material 510 having at least one layer 520 and the deposited substantially completely solid particles of the substantially non-volatile composition 4, thereon. The hot zone, optionally 407a or 407b, of the belt press 407, is adapted to heat said substantially completely solid particles of the substantially non-volatile composition 4 on the at least one layer 520 of the reinforcement material 510 to less than or equal to about 260° C. at greater than or equal to 0.01 bar pressure. The zones 407a or 407b may be hot or cold temperature exchangers, that provide either heat or cold to the reactive drapable pre-preg 500.

In one embodiment, the cold zone, optionally 407a or 407b, of the belt press 407, depicted in FIGS. 1, 10, and 13, and described herein, is adapted to receive a fully impregnated and cured thermoset composite sheet from the hot zone of the belt press 407, and to cool said fully impregnated and cured thermoset composite sheet to 25° C.

In one embodiment, FIG. 13 depicts particles of the substantially non-volatile composition 4 are deposited on a releasable surface 540 of the film 530. The releasable surface 540 of the film 530 may be releasable because it has a release agent on the releasable surface 540, e.g., a releasable coating between the composition 4 and the film. The film 530 may be paper and the releasable coating may be a silicone agent. The particles of the composition 4 may be releasably fixed on the releasable surface 540 of the film 530 by passing the combination of film 530 and composition 4 through the press 450, e.g. a cylindrical press having a heating element.

In this embodiment, as in FIG. 13, the reinforcement material 510 may be overlaid on the releasable surface 540 of the film 530 so that the substantially non-volatile composition 4 is sandwiched between the at least one layer 520 of the reinforcement material 510 and the releasable surface 540 of the film 530. The film is then released, leaving the composition 4 as a deposit on the at least one layer 520 of the reinforcement material 510. In this embodiment, the film 530 is releasably coupled to composition 4. The film 530 is made from a material selected from the group consisting of paper coated with silicone release agent. Alternatively, the film 530 may be polytetrafluoroethylene (PTFE), perfluoroalkoxy polymer resin, PFA, polyfluoroalkanes, or polyethylene film, and polypropylene film.

The foregoing description of the embodiments of this invention has been presented for purposes of illustration and description. It is not intended to be exhaustive or to limit the invention to the precise form disclosed, and obviously, many modifications and variations are possible.

I claim:

1. A method for making a reactive polymer pre-impregnated reinforcement material, comprising:
providing a substantially non-volatile composition, comprising substantially completely solid particles of at least one heat curable thermoset resin, wherein the only volatile components of the composition are residual water or residual solvent:
depositing a layer of the substantially non-volatile composition on a fabric or assemblage of reinforcing fiber to be impregnated,
wherein the particles of the substantially non-volatile composition are solid at ambient temperature and are applied to the fabric or assemblage of reinforcing fiber to be impregnated at ambient temperature; and
forming a pre-preg by heating the substantially completely solid particles of the substantially non-volatile composition, so that the substantially completely solid particles partially melt, wherein the fabric or assemblage is impregnated by the partially melted composition, and the partially melted solid particles of the substantially non-volatile composition adhere to the fabric or assemblage of reinforcing fiber.

2. The method of claim 1, comprising:
applying heat and pressure or vacuum to the pre-preg;
essentially completely melting the partially melted particles of the composition; and
substantially completely impregnating the fabric or assemblage of reinforcing fiber with the melted composition.

3. The method of claim 1, wherein the substantially completely solid particles of the composition are selected from the group consisting of epoxy resins, unsaturated polyester resins, vinyl ester resins, thermoset polyurethane resins, phenol-formaldehyde resins (phenolic resins), polyimide resins, silicone resins, crosslinkable thermoset resins, and combinations thereof.

4. The method of claim 1, wherein the substantially completely solid particles of the composition are pre-catalyzed and the particles of the composition are substantially completely solid at room temperature.

5. The method of claim 1, wherein the fabric or assemblage of reinforcing fiber is selected from the group consisting of carbon fiber, glass fiber, basalt fiber, polymer fiber, aramid fiber, steel fiber, natural fiber, and combinations thereof.

6. The method of claim 5, wherein the fabric or assemblage of reinforcing fiber is selected from the group consisting of roving, tape, web, weave, bi- or -multi-axial fabrics, knit, braid, random mat, fleece, and combinations thereof.

7. The method of claim 1, wherein the substantially completely solid particles of the composition are dried to remove moisture or solvent prior to depositing the substantially completely solid particles of the composition on the fabric or assemblage of reinforcing fiber to avoid voids in the formed pre-preg.

8. The method of claim 1, wherein the layer of the substantially completely solid particles of the non-volatile composition is formed by depositing the substantially completely solid particles of the non-volatile composition by a particle deposition unit.

9. The method of claim 8, wherein the particle deposition unit is a powder sprinkling device and a field of deposition of the sprinkling device is from about 0 to about 4.0 m wide.

10. The method of claim 2, wherein applying heat and pressure or vacuum to the pre-preg includes curing in a low pressure double belt press.

11. The method of claim 2, wherein applying heat and pressure or vacuum to the pre-preg includes curing in a vacuum bagging process.

12. A drapable polymer pre-impregnated reinforcement material, comprising:
a porous substrate having at least one layer; and
randomly spaced particles of a substantially non-volatile composition, comprising at least one reactive thermoset resin, thereon,
wherein the only volatile components of the composition are residual water or solvent,
wherein a portion of each of the randomly spaced particles is impregnated into interstices of the at least one layer of the porous substrate, therein, and
wherein a space, therebetween, separates adjacent randomly spaced particles.

13. The drapable polymer pre-impregnated reinforcement material of claim 12, wherein the porous substrate having at least one layer comprises fiber reinforced sheets impregnated with the at least one reactive thermoset resin(s), which may be subsequently cured to form a thermoset composite sheet.

14. The drapable polymer pre-impregnated reinforcement material of claim 13, wherein the fibers of the fiber reinforced sheets are selected from the group consisting of carbon fiber, glass fiber, basalt fiber, polymer fiber, aramid fiber, steel fiber, natural fiber, and combinations thereof.

15. The drapable polymer pre-impregnated reinforcement material of claim 12, wherein the composition is selected from the group consisting of epoxy resins, unsaturated polyester resins, vinyl ester resins, thermoset polyurethane resins, phenol-formaldehyde resins (phenolic resins), polyimide resins, silicone resins, crosslinkable thermoset resins, and combinations thereof.

16. The drapable polymer pre-impregnated reinforcement material of claim 15, wherein the crosslinkable thermoplastic resins are selected from the group consisting of crosslinkable polyethylene resins, crosslinkable polypropylene resins, crosslinkable polyvinyl chloride resins, crosslinkable polymers, and combinations thereof.

17. The drapable polymer pre-impregnated reinforcement material of claim 12, wherein the composition is epoxy based or unsaturated polyester based, and wherein the epoxy based or unsaturated polyester based thermoset resin(s) are solid at room temperature.

18. A method for forming a drapable polymer pre-impregnated reinforcement material, comprising:
providing a the porous substrate having having at least one layer; and
forming an array of a substantially non-volatile composition, comprising substantially uniformly spaced and substantially completely solid reactive thermoset particles, and covering a portion of the at least one layer, thereon,
wherein the only volatile components of the composition are residual water or solvent:
partially melting the array of substantially completely solid reactive thermoset particles; and
fixing the partially melted array by impregnating the melt into interstices of a portion of the at least one layer of the porous substrate, therein,
wherein a remaining portion of the at least one layer remains uncovered by the array.

19. The method of claim 18, wherein the substantially solid reactive thermoset particles of the array have a melt viscosity between about 5 cps and about 5,000 cps.

20. The method of claim 18, wherein the porous substrate having at least one layer comprises fiber reinforced sheets impregnated with the at least one reactive thermoset resin(s), which may be subsequently cured to form a thermoset composite sheet.

21. The method of claim 18, wherein the substantially solid reactive thermoset particles of the array are selected from the group consisting of epoxy resins, unsaturated polyester resins, vinyl ester resins, thermoset polyurethane resins, phenol-formaldehyde resins (phenolic resins), polyimide resins, silicone resins, crosslinkable thermoset resins, and combinations thereof.

22. The method of claim 21, wherein the substantially solid reactive thermoset particles of the array are pre-catalyzed and the reactive thermoset resin particles are solid at room temperature.

23. The method of claim 18, wherein fibers of the porous substrate having at least one layer is selected from the group consisting of carbon fiber, glass fiber, basalt fiber, polymer fiber, aramid fiber, steel fiber, natural fiber, and combinations thereof.

24. The method of claim 18, wherein fibers of the porous substrate having at least one layer is selected from the group consisting of roving, tape, web, weave, bi- or -multi-axial fabrics, knit, braid, random mat, fleece, and combinations thereof.

25. The method of claim 18, wherein the substantially solid reactive thermoset particles of the array are dried to remove moisture or solvent to avoid voids in the formed pre-preg or in a composite sheet formed from the pre-preg.

26. The method of claim 18, wherein the array of substantially uniformly spaced and substantially completely solid reactive thermoset particles is formed by depositing the substantially completely solid particles of the at least one heat curable thermoset resin by a particle deposition unit.

27. The method of claim 26, wherein the powder deposition unit is a powder sprinkling device and a field of deposition of the sprinkling device is at least 4.0 m wide.

28. An apparatus for forming a drapable polymer pre-impregnated reinforcement material, comprising:
a feeder roll of reinforcement material;
a receiver roll of drapable polymer pre-impregnated reinforcement material; and
a conveyor belt having the reinforcement material from the feeder roll thereon;
a particle deposition hopper charged with a substantially non-volatile composition, comprising substantially completely solid reactive thermoset particles,
wherein the only volatile components of the substantially non-volatile composition are residual water or solvent:
a heating device adapted to substantially uniformly maintain a temperature of the substantially non-volatile composition on at least one layer of the reinforcement material for a residence time, during which the particles of the composition on the at least one layer of the reinforcement material reside in the oven; and
a conveyor belt,
wherein residence time that the particles of the composition reside on the at least one layer of the reinforcement material is based on the conveyor belt's rate.

29. The apparatus of claim 28, wherein the particle deposition hopper is adapted to deposit between 20 g/m² and about 2,000 g/m² of the particles of the composition, based on the surface area (m²) of the reinforcement material.

30. A method for forming a thermoset composite sheet, comprising:
providing at least one feeder roll, wherein one of the feeder rolls provides reinforcement material, a receiver roll of drapable polymer pre-impregnated reinforcement material and a conveyor belt having the reinforcement material from the feeder roll thereon,
wherein the reinforcement material has a fiber content based on total weight of the thermoset composite sheet;
providing a particle deposition hopper charged with a substantially non-volatile composition,
wherein the substantially non-volatile composition comprises substantially completely solid reactive thermoset particles, and
wherein the only volatile components of the substantially non-volatile composition are residual water or solvent;
depositing the particles of the substantially non-volatile composition on at least one layer of the reinforcement material;
providing a thermal heating unit for heating the substantially non-volatile composition for a residence time for which the substantially solid reactive thermoset particles of the substantially non-volatile composition reside on the at least one layer of the reinforcement material in the oven;
providing a conveyor belt wherein residence time that the particles of the substantially non-volatile composition reside on the at least one layer of the reinforcement material is based on the conveyor belt's rate; and
providing a belt press after the heating unit,
wherein the belt press has a hot zone and a cold zone.

31. The method of claim 30, wherein the particle deposition hopper is adapted to deposit between 20 g/m² and about 2,000 g/m² of the particles of the composition, based on the surface area (m²) of the reinforcement material.

32. The method of claim 30, wherein the oven is adapted to melt the particles of the substantially non-volatile composition on the at least one layer of the reinforcement material in a temperature range between about 40° C. and about 230° C.

33. The method of claim 30, wherein the hot zone is adapted to receive drapable polymer pre-impregnated reinforcement material and to heat said pre-impregnated reinforcement material to less than or equal to about 260° C. at greater than or equal to 0.01 bar pressure.

34. The method of claim 30, wherein the cold zone is adapted to receive a fully impregnated and cured thermoset composite sheet and to cool said fully impregnated and cured thermoset composite sheet to 25° C.

35. The method of claim 30, comprising a second feeder roll, wherein the second feeder roll provides a carrier film, so that the composition is sandwiched between the reinforcement material and the releasable surface of the carrier film.

36. The method of claim 35, wherein the releasable film is either a film coated with a release agent, wherein the release agent is selected from the group consisting of silicone release agent or polytetrafluoroethylene (PTFE), perfluoroalkoxy polymer resin, PFA, polyfluoroalkanes, or polyethylene film, and polypropylene film.

37. A method for making a reactive polymer pre-impregnated reinforcement material, comprising:
providing a substantially non-volatile mixture, comprising substantially completely solid particles of a heat curable thermoset resin and substantially completely solid particles of a heat curable thermoplastic resin,
wherein the only volatile components of the substantially non-volatile mixture are residual water or solvent:
depositing a layer of the mixture on a fabric or assemblage of reinforcing fiber to be impregnated,
wherein the particles of the substantially non-volatile mixture are solid at ambient temperature and are deposited onto the fabric or assemblage of reinforcing fiber to be impregnated at ambient temperature; and
forming a pre-preg by heating the particles of the substantially non-volatile mixture, so that the solid particles partially melt, wherein the fabric or assemblage is impregnated by the partially melted thermoset resin, and the partially melted solid particles adhere to the fabric or assemblage of reinforcing fiber.

38. The method of claim 35, wherein the thermoplastic resin is from about 0% to about 40% by weight of the composition and is not soluble in the melted composition.

39. The method of claim 36, wherein the substantially completely solid particles of thermoplastic resin are a different color than the particles of the substantially completely solid thermoset resin.

40. The method of claim 39, wherein the substantially completely solid particles of thermoplastic resin are a different viscosity than the particles of the substantially completely solid thermoset resin.
